(19) United States
(12) Patent Application Publication
(10) Pub. No.: US 2013/0046592 A1
(43) Pub. Date: Feb. 21, 2013

(54) Mobile Application for Providing Vehicle Information to Users

(71) Applicant: Steven J. Ross, Livonia, MI (US)

(72) Inventor: Steven J. Ross, Livonia, MI (US)

(73) Assignee: GENERAL MOTORS LLC, Detroit, MI (US)

(21) Appl. No.: 13/211,913

(22) Filed: Aug. 17, 2011

(51) Int. Cl. G06F 3/048; G06Q 30/00

(52) U.S. Cl. 705/14.4; 715/810

(57) ABSTRACT

The described method and system provide for quickly and intuitively presenting users with a variety of detailed vehicle information through a mobile application on a mobile computing device. The mobile computing device is preferably a mobile phone having at least a camera, a display, a processor, and a tangible non-transient computer-readable medium for storing appropriate programming and vehicle information. By pointing a camera at a vehicle, the mobile computing device receives images of the vehicle and may identify various objects or features of the vehicle. The mobile computing device then overlays these identifications on top of images of the vehicle displayed to a user corresponding to the location of the identified objects or features in the images. The user can then select the various objects or features to receive further detailed vehicle information regarding the selection.

### BACKGROUND OF THE INVENTION

Wireless communication services available for mobile vehicles, such as navigation and roadside assistance, have increased rapidly in recent years. Telematics services that are now available to consumers include navigation, infotainment, communication, maintenance and diagnostics, system updates, and emergency services, to name but a few. At the same time, the popularity of smartphones, netbooks, tablet computing devices, laptops and other portable electronics devices has also continued to grow. Accordingly, the popularity of mobile applications is also growing rapidly, as mobile phones and tablets now have the capabilities to provide consumers with increasingly sophisticated programs suitable for a broad range of tasks.

However, even with the rapid development of technology and the vast amount of information readily available over the Internet, car owners are still often unfamiliar with the basics of how to properly use and maintain their motor vehicles. Rather than take the time to read an owner's manual or look up features and solutions on the Internet, car owners often just barely get by with knowledge passed onto them by others regarding only the bare necessities, such as bringing the car in for an oil change and doing an occasional maintenance check-up. These car owners may be unaware of many features offered by modern vehicles, such as telematics services and special child safety seat locking mechanisms, as well as being unaware of conventional routine tasks such as how to check their oil or change a tire.

Thus, it is an object in part to provide a system and method for providing users of mobile computing devices with detailed information relating to their vehicles with an easy-to-use and engaging interface. However, while this is an object underlying certain implementations of the invention, it will be appreciated that the invention is not limited to systems that solve the problems noted herein. Moreover, the inventors have created the above body of information for the convenience of the reader and expressly disclaim all of the foregoing as prior art; the foregoing is a discussion of problems discovered and/or appreciated by the inventors, and is not an attempt to review or catalog the prior art.

### BRIEF SUMMARY OF THE INVENTION

The invention provides a system and method for quickly and intuitively provides users with a variety of detailed vehicle information through a mobile application on a mobile computing device. The mobile computing device is preferably a mobile phone having at least a camera, a display, a processor, and a tangible non-transient computer-readable medium for storing appropriate programming and vehicle information.

Using a camera, the mobile computing device receives at least one image corresponding to a vehicle, identifies at least one object in the at least one image, and displays the at least one image with overlaid information corresponding to any identified objects in the at least one image. The user may further provide the mobile computing device with an input corresponding to one of the identified objects (e.g. by tapping on an overlaid label on a touch screen display) and the mobile computing device further displays detailed vehicle information pertaining to the selected identified object.

The detailed vehicle information may be stored at the mobile computing device or may be received by the mobile computing device over a network. In further implementations, the detailed vehicle information may be based on the location of the user or the vehicle, may be based on the vehicle make, model or year, or may include advertisements (e.g. for particular brands of products).

The mobile computing device may further include at least one position sensor, such as a gyroscope, accelerometer, and compass, and use the position sensor to determine relative motion between images received at the mobile computing device. Using this relative motion, the mobile computing device may better adjust the display of overlaid information to correspond to user motion.

Other objects and advantages of the invention will become apparent upon reading the following detailed description and upon reference to the drawings.

### BRIEF DESCRIPTION OF THE SEVERAL VIEWS OF THE DRAWINGS

FIG. 1 is a schematic diagram of an operating environment for a mobile computing device usable in implementations of the described principles;

FIG. 2 is a flowchart illustrating a process for presenting detailed vehicle information to a user in accordance with an implementation of the described principles;

FIG. 3 is an exemplary screenshot of a screen that may be presented to a user of a mobile application in accordance with an implementation of the described principles;

FIG. 4 is another exemplary screenshot of a screen that may be presented to a user of the mobile application in accordance with an implementation of the described principles; and

FIG. 5 is a diagram showing various exemplary items of information that may be presented to a user in an implementation in accordance with an implementation of the described principles.

### DETAILED DESCRIPTION OF THE INVENTION

Before discussing the details of the invention and the environment wherein the invention may be used, a brief overview is given to guide the reader. In general terms, not intended to limit the claims, the invention is directed to a mobile application on a mobile computing device that utilizes a camera to provide a user with detailed vehicle information regarding a vehicle based on where the camera is pointed. The mobile computing device presents the camera image to the user on a display, with an overlay labeling recognizable features of the vehicle. The user can select the labels (e.g. by touching them if it is a touchscreen display or through other input methods) and receive additional information regarding the selected label.

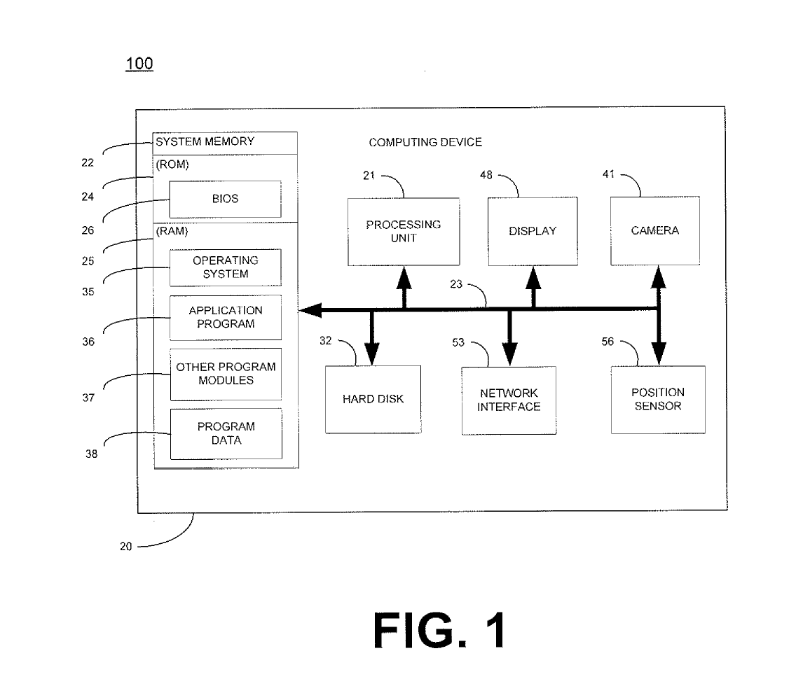

Given this overview, an exemplary environment in which the invention may operate is described hereinafter. It will be appreciated that the described environment is an example, and the components depicted do not necessarily imply any limitation regarding the use of other environments to practice the invention. With reference to FIG. 1 there is shown an example of a system 100 that may be used with the present method and system and generally includes a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory may include read only memory (ROM) 24 and random access memory (RAM) 25. A basic input/output system (BIOS) 26, containing the basic routines that help to transfer information between elements within the computing device 20, such as during start-up, may be stored in ROM 24. The computing device 20 may further include a hard disk 32. The hard disk may provide nonvolatile storage of computer readable instructions, data structures, program modules and other data for the computing device 20. It will be appreciated that although only a hard disk is depicted, computer readable instructions, data structures, program modules and other data for the computing device 20 may be stored on other media such as magnetic disks, optical discs, flash memory, or other types of electronic memory, accessible through the appropriate drives.

In a preferred implantation, the computing device 20 may be a mobile phone, but it will be appreciated that other types of computing environments may be employed and are contemplated by this invention, including but not limited to, tablet computers, personal computers, hand-held or laptop devices, programmable consumer electronics, distributed computing environments that include any of the above systems or devices, and the like.

Although not required, aspects of the invention may be described in the general context of computer-executable instructions, such as program modules, being executed by a personal computer. Generally, program modules include routines, programs, objects, components, data structures, etc. that perform particular tasks or implement particular abstract data types. The depicted computing system environment in FIG. 1 is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The program modules stored on the ROM 24, RAM 25, or hard disk 32 may include an operating system 35, one or more applications programs 36, other program modules 37, and program data 38. It will be appreciated by those of skill in the art that the execution of the various machine-implemented processes and steps described herein may occur via the computerized execution of computer-executable instructions stored on a tangible computer-readable medium, e.g., RAM, ROM, PROM, volatile, nonvolatile, or other electronic memory mechanism.

A user may enter commands and information into the computing device 20 through input devices such as a touch-screen display 48 or other input devices such as a keyboard or pointing device (not depicted). Other input devices (also not depicted) may include a microphone, joystick, game pad, satellite dish, scanner, or the like. These and other input devices may be connected to the processing unit 21 through an appropriate interface such as a universal serial bus (USB) or may be built into the computing device itself. In addition to the display 48, the computer may include other peripheral output devices such as speakers and printers (not depicted).

The computing device 20 may further include a network interface 53 and appropriate hardware for accessing local area networks, wireless networks, and the Internet, and for communicating with vehicle components, other devices, or a communications gateway using other wireless technologies such as shorter-range technologies including, but not limited to, WiFi, Bluetooth, ZigBee, and RFID. In a further implementation, the computing device 20 may utilize a vehicle's telecommunications module 114 and the computing device's connection with the vehicle components (which may be wired or wireless) to send and receive information over a wireless network.

The computing device 20 further includes a camera 41, capable of taking single images or continuous video (i.e. a sequence of images), as well as position sensor equipment 56, such as, for example, gyroscopes, accelerometers, and compasses. Using the inputs from the position sensor equipment 56, the processing unit 21 and relevant program modules may determine the relative motion of the computing device 20 utilizing motion tracking technology known to those skilled in the art.

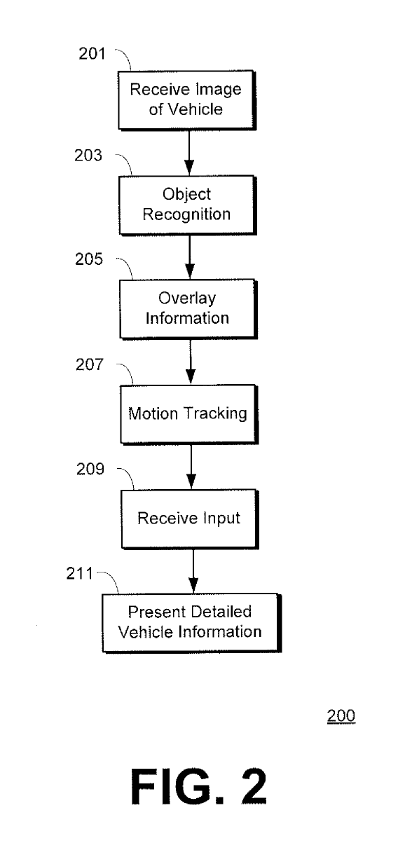

In a preferred embodiment, the computing device 20 is a mobile phone having a touch screen, a camera, gyroscope, accelerometer, appropriate programming and adequate processing power to execute the computer-implemented steps described herein. Various types of commercially available smartphones have these features or similar features and are capable of performing the processes described herein with appropriate programming. With further reference to the architecture of FIG. 1, and turning more specifically to FIG. 2, a process 200 for presenting detailed vehicle information to a user of a mobile application is depicted. First, a user points the camera on the mobile phone at a vehicle, for example, by opening the hood of the vehicle and pointing it at the engine compartment. Using conventional computer vision and object recognition technology known to those skilled in the art, the mobile phone analyzes the image data it receives to determine the position of certain known objects 203 such as an engine, a washer fluid cap, an oil cap, and a battery. The mobile phone then overlays labels 205 onto the recognized objects onto the image such that the field of view presented to the user by the mobile phone's display includes the image of the engine compartment in the background with relevant labels superimposed on it.

In one implementation, the overlaid information may be based on a single image captured by the mobile phone's camera. In a further implementation, the camera may be feeding a video to the display of the mobile phone, and if the user moves the mobile phone, such as panning it or rotating it such that it views a different portion of the engine compartment, the mobile phone tracks the motion of the mobile phone 207 using the position sensors of the phone (e.g. gyroscope, accelerometer, compass or a combination thereof). This allows the mobile phone to move the overlaid information together with the motion of the background images, as well as presenting new overlay information if a new recognized object appears in the camera's field of view.

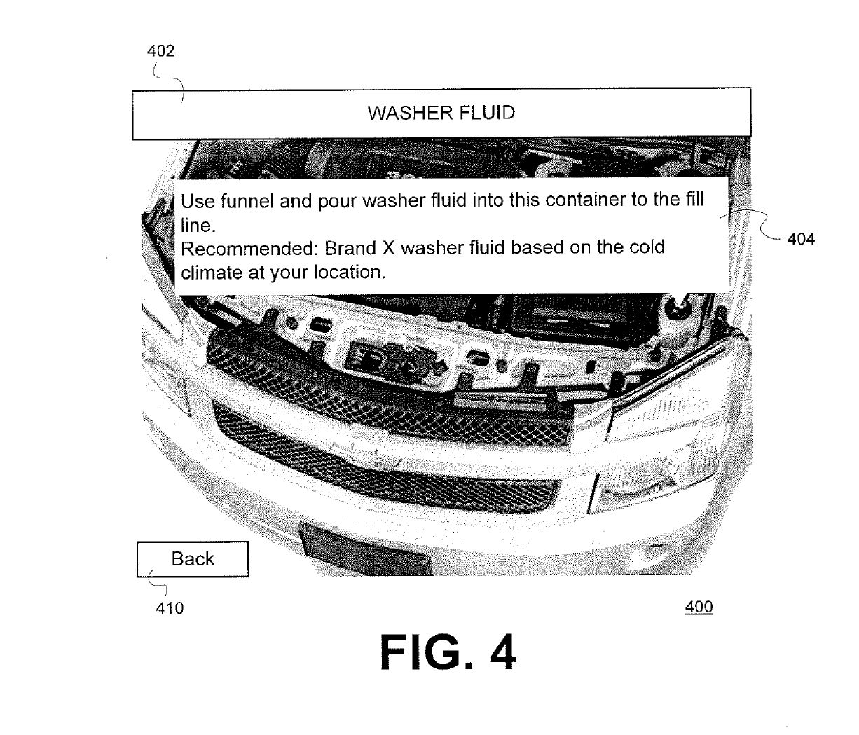

The user may further select an item of overlaid information 209, for example, by tapping the touch screen display of the mobile phone on one of the overlaid labels. Upon receiving this user input, the mobile phone may present further detailed vehicle information to the user. In one implementation, the further detailed vehicle information presented may be overlaid upon a background showing the mobile phone's field of view, similar to the presentation of the overlaid labels (this is depicted by FIG. 4, discussed in further detail below). In another implementation, selecting an overlaid label may take the user to a screen with a different format, such as by redirecting the user to an informative website or a stored database entry (e.g. a stored page with information from the owner's manual, a glossary entry, etc.).

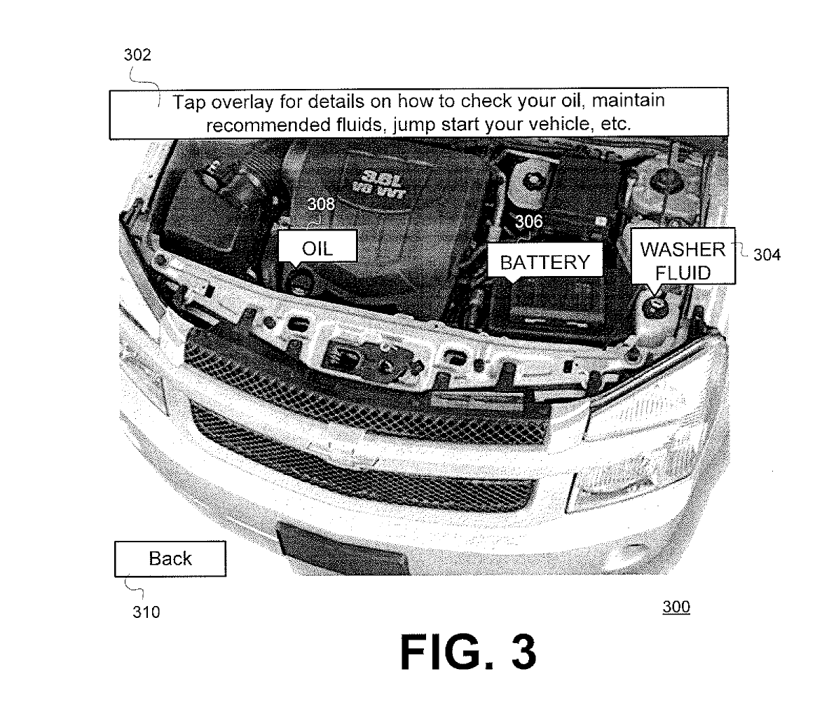

This described implementation may be better understood in the context of an example. FIG. 3 depicts an exemplary screenshot 300 of a mobile phone's field of view when the camera is pointed at the engine compartment of a vehicle. It will be appreciated that this is merely an example, and that other implementations may include different recognized objects, other presentation formats, different mobile application instructions, etc. At the top of the screen, the user is presented with instructions on how to use this mobile application 302, which inform the user that tapping on one of the labels will allow the user to view more detailed information. The labels shown in this example are for oil 308, battery 306, and washer fluid 304. The user also has the option of pressing a “Back” button 310 that would allow the user to return to a previous screen (e.g. going back to a main menu or exiting/minimizing the mobile application).

If the user taps on the washer fluid label 304 in FIG. 3 in this example, the mobile phone will then present the user with the exemplary screenshot 400 of FIG. 4, which includes detailed instructions regarding the washer fluid 404. In this example, the top of the screen shows that washer fluid has been selected 402, and a “Back” button 410 remains in the bottom left to allow the user to go back to viewing the overlaid labels of FIG. 3. The detailed instructions pertaining to washer fluid 404 are featured on the screen and include instructions regarding how to maintain the vehicle's washer fluid supply. Furthermore, the mobile phone may recommend and advertise a certain brand (e.g. “Brand X”) of washer fluid to the user, and, in a further implementation, the recommendation/advertisement may be based on the vehicle type, the location of the vehicle, the location of the user, the climate in that location, and a variety of other factors as determined or stored by the mobile phone.

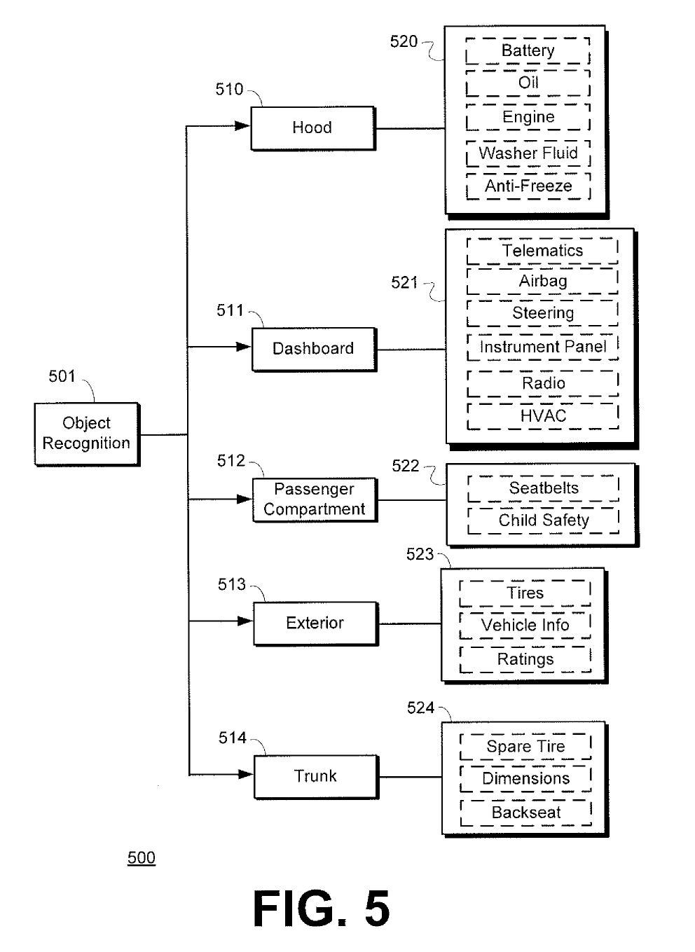

FIG. 5 is a diagram 500 depicting exemplary objects that may be recognized by the mobile phone. In the implementation depicted by FIG. 5, the mobile phone may first attempt to recognize the area of a vehicle captured by its field of view, whether it is the hood 510, dashboard, 511, passenger compartment 512, exterior 513, or trunk 514, and then further recognize objects of interest in that area (e.g. battery, oil, engine, washer fluid, anti-freeze 520 for the hood 510). Table I below provides an example of the type of information that may be presented to the user regarding each item in further detail.

TABLE I
Exemplary Objects of Interest

| Area | Objects of Interest | Detailed Information Presented to the User |
|---|---|---|
| Hood | Battery | Type; remaining charge; instructions on how to |
| | | jump-start; when to replace; etc. |
| | Oil | Oil remaining; recommended brand; instructions on |
| | | how to change; when to change; etc. |
| | Engine | Type; specifications; maintenance instructions; etc. |
| | Washer Fluid | Amount remaining; recommended brand; |
| | | instructions on how to fill; when to fill; etc. |
| | Anti-Freeze | Amount remaining; recommended brand; |
| | | instructions on how to fill; when to fill; etc. |
| Dashboard | Telematics | Information on available services; instructions on |
| | | how to use services; pricing information; etc. |
| | Airbag | Airbag information; safety recommendations; |
| | | maintenance instructions; etc. |
| | Steering | Relevant information (e.g. FWD, RWD, 4WD); |
| | | instructions on optimal steering procedure; etc. |
| | Instrument Panel | Explanation of speedometer, tachometer, and |
| | | odometer; current readings; etc. |
| | Radio | Type information; instructions on how to use; etc. |
| | HVAC | Instructions on how to use; current settings; etc. |
| Passenger | Seatbelts | Safety recommendations and warnings; applicable |
| Compartment | | laws; how to use; etc. |
| | Child Safety | Information on special features; instructions on |
| | | attaching child car seats; etc. |
| Exterior | Tires | Type; instructions on how to fill; recommended |
| | | brand; recommended pressure; when to replace; etc. |
| | Vehicle Info | General info (e.g. make, model, year, color); |
| | | vehicle features; etc. |
| | Ratings | User reviews from surveys, magazines, Internet; |
| | | awards; etc. |
| Trunk | Spare Tire | Recommended usage instructions; instructions on |
| | | how to change tires; etc. |
| | Dimensions | Storage space information; instructions on how to |
| | | transport large objects; etc. |
| | Backseat | Instructions on how to put the backseat down to |
| | | increase space; etc. |

It will be appreciated that the objects depicted in FIG. 5 and Table I are merely examples of items as to which a mobile application may provide additional information to a user. Other implementations may include more or less items. Furthermore, it will be appreciated that it is not necessary to divide the objects into categories such as hood 510, dashboard 511, passenger compartment 512, exterior 513, or trunk 514.

This detailed information may be stored at the mobile phone or may be stored at a remote location on a network and retrieved by the mobile phone over the network. Furthermore, it will be appreciated that the recognizable objects and detailed information may be vehicle-specific (i.e. different vehicles will have different features and designs) or location-specific (i.e. certain detailed information, such as a recommendation for tire type or oil type that should be used, may be based on the location of the vehicle or user). In different implementations of the present invention, the mobile applications may be particularly tailored to specific types of vehicles or may be generic and include the stored information off a variety of vehicles (or means for accessing such information). For a generic mobile application, the mobile application may require input from a user to specify a certain make, model, and/or year of vehicle that the camera is pointed at, or it may be programmed to be able to recognize certain types of vehicles. In yet another further implementation, a mobile application may be able to connect (via a connection port or wireless connection) to a vehicle telematics unit to obtain information regarding the vehicle (such as the vehicle type or other specific information such as diagnostic information and instrument panel readings).

Thus, it will be appreciated that the described system and method allows for mobile applications to quickly and intuitively provide users with a variety of detailed vehicle information. It will also be appreciated, however, that the foregoing methods and implementations are merely examples of the inventive principles, and that these illustrate only preferred techniques.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for presenting detailed vehicle information to a user on a mobile computing device, the method comprising:
receiving, at the mobile computing device, at least one image corresponding to a vehicle;
identifying, at the mobile computing device, at least one object in the at least one image; and
displaying, at the mobile computing device, the at least one image with overlaid information corresponding to the at least one identified object based on the location of the at least one identified object in the at least one image.

2. The method of claim 1, further comprising:
receiving, at the mobile computing device, a user input corresponding to a selection of an identified object; and
displaying, at the mobile computing device, detailed vehicle information corresponding to the selected identified object.

3. The method of claim 2, wherein the detailed vehicle information is stored at a database at the mobile computing device.

4. The method of claim 2, wherein the detailed vehicle information is received by the mobile computing device over a network.

5. The method of claim 1, wherein the received at least one image is part of a sequence of images and the method further comprises:
determining, at the mobile computing device, relative motion between the at least one image with respect to a previously received image based on at least one position sensor at the mobile computing device; and
the displaying the at least one image with overlaid information corresponding to the at least one identified object is further based on the determined relative motion.

6. The method of claim 5, wherein the at least one position sensor is at least one of a gyroscope, an accelerometer, and a compass.

7. The method of claim 1, wherein the mobile computing device is a mobile phone.

8. The method of claim 2, wherein the detailed vehicle information corresponding to the selected identified object is based on at least one of the location of one of the user and the vehicle.

9. The method of claim 2, wherein the detailed vehicle information corresponding to the selected identified object is based on at least one of the make, model and year of the vehicle.

10. The method of claim 2, wherein the detailed vehicle information corresponding to the selected identified object includes an advertisement.

11. A mobile computing device for presenting detailed vehicle information to a user comprising a camera, a display, a processor, and a tangible non-transient computer-readable medium, the computer readable medium having computer-executable instructions stored there on, the computer-executable instructions comprising:
instructions for receiving at least one image corresponding to a vehicle;
instructions for identifying at least one object in the at least one image; and
instructions for displaying the at least one image with overlaid information corresponding to the at least one identified object based on the location of the at least one identified object in the at least one image.

12. The mobile computing device of claim 11, wherein the computer-executable instructions further comprise:
instructions for receiving a user input corresponding to a selection of an identified object; and
instructions for displaying detailed vehicle information corresponding to the selected identified object.

13. The mobile computing device of claim 12, wherein the detailed vehicle information is stored on the computer-readable medium.

14. The mobile computing device of claim 12, further comprising a network access device, and wherein the detailed vehicle information is received by the mobile computing device over a network.

15. The mobile computing device of claim 11, further comprising at least one position sensor, and wherein the received at least one image is part of a sequence of images, and wherein the computer-executable instructions further comprise:
instructions for determining relative motion between the at least one image with respect to a previously received image based on the at least one position sensor at the mobile computing device; and
wherein the instructions for displaying the at least one image with overlaid information corresponding to the at least one identified object are further based on the determined relative motion.

16. The mobile computing device of claim 15, wherein the at least one position sensor is at least one of a gyroscope, an accelerometer, and a compass.

17. The mobile computing device of claim 11, wherein the mobile computing device is a mobile phone.

18. The mobile computing device of claim 12, wherein the detailed vehicle information corresponding to the selected identified object is based on at least one of the location of one of the user and the vehicle.

19. The mobile computing device of claim 12, wherein the detailed vehicle information corresponding to the selected identified object is based on at least one of the make, model and year of the vehicle.

20. The mobile computing device of claim 12, wherein the detailed vehicle information corresponding to the selected identified object includes an advertisement.
